(19) United States
(12) Patent Application Publication
(10) Pub. No.: US 2024/0367645 A1
(43) Pub. Date: Nov. 7, 2024

(54) System and Method for Increasing Sensitivity of a Collision Avoidance System of a Vehicle Based on Driver Awareness State

(71) Applicant: Bendix Commercial Vehicle Systems LLC, Avon, OH (US)

(72) Inventor: Subashish Sasmal, Avon, OH (US)

(73) Assignee: Bendix Commercial Vehicle Systems LLC, Avon, OH (US)

(21) Appl. No.: 18/141,604

(22) Filed: May 1, 2023

(51) Int. Cl. B60W 30/09; B60W 40/08; B60W 50/16; G06V 20/59

(52) U.S. Cl. CPC B60W 30/09; B60W 40/08; B60W 50/16; G06V 20/597; B60W 2040/0818; B60W 2040/089; B60W 2050/143; B60W 2050/146; B60W 2420/403; B60W 2420/408; B60W 2420/54; B60W 2510/182; B60W 2540/18; B60W 2540/21; B60W 2540/225; B60W 2540/229

(57) ABSTRACT

A system and method are provided for increasing sensitivity of a collision avoidance system of a vehicle based on driver awareness state. In one embodiment, a determination is made regarding whether or not the driver is alert based on an output of a sensor in the vehicle, such as a driver-facing camera or a sensor that detects a state of the vehicle. If the driver is found not to be alert, a lower confidence level threshold is used by a collision avoidance system of the vehicle (e.g., to more aggressively apply automatic braking). Other embodiments are provided.

### BACKGROUND

A vehicle can have an advanced driver assistance system having advanced emergency braking functionality. In operation, a forward-facing sensor of the advanced driver assistance system collects information about vehicles ahead of the vehicle. Based on the collected information, the advanced driver assistance system determines a likelihood that the vehicle will collide with another vehicle. If the likelihood is above a threshold, the advanced emergency braking system automatically applies the vehicle's brakes in an attempt to avoid the predicted collision.

### BRIEF DESCRIPTION OF THE DRAWINGS

FIG. 1 is a diagram of an advanced driver assistance system of a vehicle of an embodiment

FIG. 2 is a flow chart of a method of an embodiment for increasing sensitivity of a collision avoidance system of a vehicle based on driver awareness state.

FIG. 3 is a graph of sensor confidence level thresholds versus driver awareness state of an embodiment.

### SUMMARY

In one embodiment, a non-transitory computer-readable storage medium storing a computer program having instructions that, when executed by one or more processors in a vehicle, cause the one or more processors to: determine that a driver alertness problem exists based on an output of a sensor in the vehicle; and in response to determining that the driver alertness problem exists, lower a confidence level threshold used by a collision avoidance system of the vehicle.

In another embodiment, a method is provided that is performed in one or more processors in a vehicle. The method comprises: determining whether a driver of the vehicle is in a first awareness state or a second awareness state based on a reading from a driver-facing sensor and/or a reading from a vehicle sensor; in response to determining that the driver of the vehicle is in the first awareness state, causing a driver assistance system of the vehicle to use a first activation criterion in assessing readings from a forward-facing sensor of the vehicle; and in response to determining that the driver of the vehicle is in the second awareness state, causing the driver assistance system of the vehicle to use a second activation criterion in assessing the readings from the forward-facing sensor of the vehicle.

In another embodiment, a vehicle safety system is provided comprising: means for monitoring for impairment of a driver of a vehicle; and means for increasing a sensitivity of an autonomous feature of the vehicle in response to detecting impairment of the driver.

Other embodiments are possible, and each of the embodiments can be used alone or together in combination.

### DETAILED DESCRIPTION

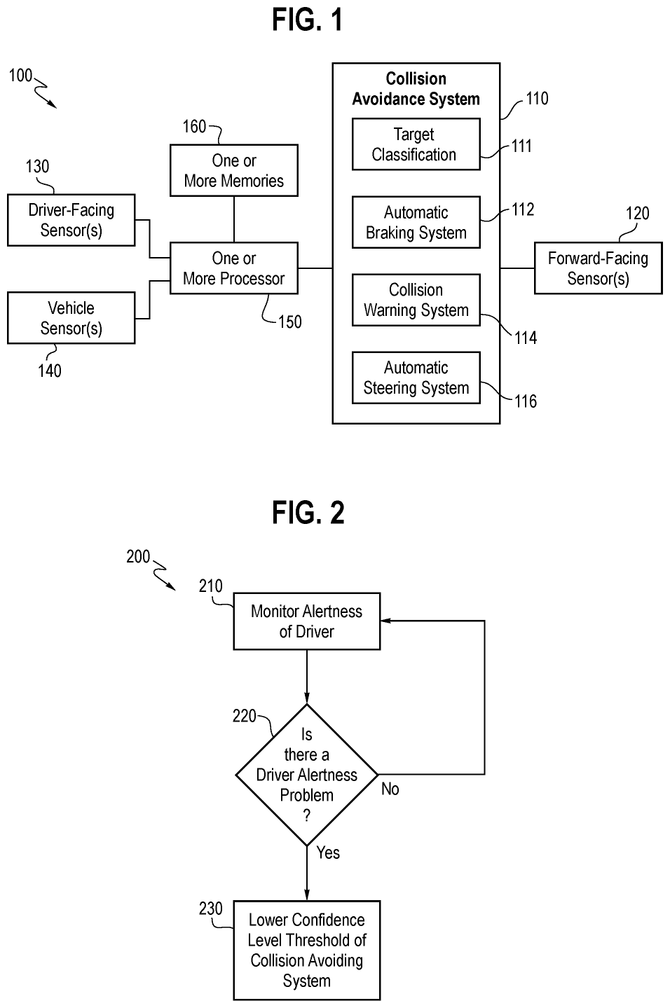

Turning now to the drawings, FIG. 1 is a diagram of an advanced driver assistance system (ADAS) 100 of a vehicle of an embodiment. The vehicle can take any suitable form, such as, but not limited to, a tractor/truck configured to tow a trailer, a general-purpose automobile (e.g., a car, a sport utility vehicle (SUV), a cross-over, a van, etc.), a bus, a motorcycle, a scooter, a moped, an e-bike, etc. As shown in FIG. 1, the advanced driver assistance system 100 of this embodiment comprises a collision avoidance system 110, forward-facing sensor(s) 120, driver-facing sensor(s) 130, vehicle sensor(s) 140, one or more processors 150, and one or more memories 160. Wired or wireless connections can be used to place the various components in FIG. 1 in communication with each other. In one embodiment, a communication network, such as a Controller Area Network (CAN), is used.

The one or more memories 160 can take any suitable form, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. In one embodiment, at least one of the one or more memories 104 is a non-transitory computer-readable storage medium capable of storing computer-readable instructions (e.g., readable program code, modules, routines, sub-routines, etc.) that can be executed by the one or more processors 150 to perform the functions described herein and, optionally, other functions. The one or more processors 150 can also take the form of a pure-hardware implementation (e.g., an application-specific integrated circuit (ASIC)) that performs function(s) without executing a computer program stored in the one or more memories 160. Also, the one or more processors 150 can perform some or all of the functions of the collision avoidance system 110, or the collision avoidance system 110 can have its own processor(s) for some or all of its functions.

The collision avoidance system 110 is configured to automatically provide one or more function to help avoid a detected impending collision with an object forward of the vehicle (e.g., another vehicle, a pedestrian, a stationary object (e.g., a telephone pole, a fire hydrant, traffic signs/lights, road debris), etc.). In the embodiment shown in FIG. 1, the collision avoidance system 110 comprises a target classification module (algorithm) 111, an automatic braking system 112 (e.g., an advanced emergency braking (AEB) system), a collision warning system 114, and/or an automatic steering system 116. The collision avoidance system 110 can have all or just some (or even one) of the systems 112, 114, 116 shown in FIG. 1, and the collision avoidance system 110 can include other system not shown in FIG. 1. Also, each of the systems 112, 114, 116 can have one or more processors to perform its function(s), or the one or more of the systems 112, 114, 116 can share processors.

In operation, the collision avoidance system 110 receives reading(s) from one or more forward-facing sensor(s) 120. The sensor(s) 120 are forward facing in that they are positioned in the vehicle so as to observe object(s) in front of the vehicle that can potentially pose a collision risk. The forward-facing sensor(s) 120 can take any suitable form, such as, but not limited to a camera, a radar, or a lidar. The forward-facing sensor(s) 120 can be used to gather images of the forward object, the distance to the forward object, the speed and trajectory (if any) of the forward object, etc. The collision avoidance system 110 is configured to analyze the reading(s) from the forward-facing sensor(s) to assess (e.g., using an algorithm) the likelihood of an impending collision with the forward object.

The one or more processors 160 can determine if target information from the forward-facing sensor(s) 120 corresponds to a relevant hazardous target, such as a moving vehicle, a stationary bike, a vulnerable road user, etc. To reach that determination, the one or more processors 160 can use a confidence threshold, such that, above that threshold, the target is classified as a relevant target to act upon when collision is imminent, and below that threshold, the target (e.g., guardrails, overhead traffic signs, etc) is classified as not relevant. The confidence threshold value can be adjustable based on information from the driver-facing sensor(s) 130. Once a target is classified as a relevant target, the one or more processors 160 can determine an estimated time to collide with the target based on the measured distance to the object, the speed/velocity of the vehicle, and the relative speed/velocity (if any) of the forward object.

If a determination is made that a collision is likely and that the driver has not already initiated adequate braking or another collision avoidance actions, the collision avoidance system 110 can automatically take one or more actions to attempt to avoid the collision. For example, the automatic braking system 112 can automatically cause activation of one or more brakes in the vehicle to attempt to slow the vehicle to avoid the collision (e.g., by sending a control signal to an electronic brake controller to activate a service brake). Additionally or alternatively, the collision warning system 114 can provide an audible or visible alert (via a speaker or display device in the cabin of the vehicle) or a tactile alert (e.g., shaking the steering wheel or the driver's seat) to get the driver's attention and prompt him to press the brake pedal. Additionally or alternatively, the automatic steering system 116 can send a control signal to automatically move the steering wheel to change the vehicle's trajectory as to avoid the forward object

To summarize, the collision avoidance system 110 in this embodiment can assess raw traffic and environment information from the forward-facing sensor(s) 120 to determine to intervene with a collision avoidance measure if there is enough confidence in the information suggesting that a collision is likely unless adequate avoidance measures are taken. For example, a confidence level value can be determined, and a collision voidance measure can be taken if the confidence level value exceeds a confidence level threshold (e.g., 75%). The threshold can be set to minimize false-positive interventions. A value below this threshold does not mean that a collision will not occur, as the system may still detect a non-zero likelihood of collision. That is, the readings from the forward-facing sensor(s) 120 can detect a collision threat before the confidence level threshold is reached.

Even if a collision avoidance action is automatically taken by the collision avoidance system 110, driver action may still be needed to avoid the collision. More specifically, many collision avoidance interventions occur when the driver is not alert, so even with the assistance of a collision avoidance system, a distracted or compromised driver may not be able to react in time in order to avoid a collision. To address this problem, the following embodiments can be used to monitor for impairment of a driver of a vehicle and increase a sensitivity of an autonomous feature of the vehicle in response to detecting impairment of the driver. For example, as shown in the flow chart 200 in FIG. 2, the one or more processors 150 can monitor the alertness of the driver using the driver-facing sensor(s) 130 (act 210). The driver-facing sensor(s) 130 can take any suitable form, such as, but not limited to, a driver-facing camera, a lidar sensor (e.g., positioned to detect head movement of the driver), an infrared sensor (e.g., positioned to observe a pupil of the driver), or a microphone (e.g., configured to detect slurred speech of the driver). As can be seen from these examples, a sensor is “driver facing” in the sense that it is positioned to observe some characteristic of the driver and does not literally need to face the driver (e.g., such as when an omni-directional microphone is used).

The one or more processors 150 can monitor the signal(s) from the driver-facing sensor(s) 130 to determine if there is a driver alertness problem (e.g., whether or not the driver is alert, the degree of alertness of the driver, etc.). This can be performed in any suitable way. For example, a driver can be deemed not alert if images/data from the sensor 130 shows that the driver has his eyes closed for more than a certain period of time, that the driver's head is nodding off, that the driver's pupils are dilated, that the driver's speech is slurred, that the driver is on the phone, that the driver is looking out the window, that the driver is asleep, that the driver's hand are off the steering wheel, etc.

Additionally or alternatively, a driver's alertness can be ascertained from one or more vehicle sensors 140 that report on a state of the vehicle. These sensor(s) 140 can take any suitable form, such as, but not limited to, radar, lidar, a vehicle location sensor, a camera, a deceleration sensor, a steering angle sensor, a wheel speed sensor, and a brake pressure sensor. For example, a driver can be deemed not alert if the sensor(s) 140 indicates excessive acceleration, excessive braking, exceeding a speed limit, excessive curve speed, excessive lane departure, lane change without turn signal, loss of video tracking, lane departure, following distance (i.e., headway) below a threshold, the driver logged in/out of a vehicle telematics system, unsmooth driving, etc.

In some embodiments, the one or more processors 150 can make a binary determination of whether or not the driver is alert (e.g., if a certain condition is observed, the driver is not alert; otherwise, the driver is alert). In that example, the driver can be in a first awareness state if that condition is not observed and in a second awareness state if that condition is observed (so, a driver alertness problem can be concluded when the derive is in the second awareness state). In other embodiments, the one or more processors 150 determine a degree of alertness. In that example, the driver can be in a first awareness state if showing initial signs of drowsiness (e.g., droopy eyelids) and in the second awareness state if showing additional signs of drowsiness (e.g., closed eyelids). As another example, the different awareness states can be assigned to different observations (e.g., the driver is on the phone in state one, the driver is looking out the window in state two, the driver is asleep in state three, etc.). Other factors can go into the alertness assessment including, but not limited to, time of day, length of time driving, length of time since last rest break, etc.

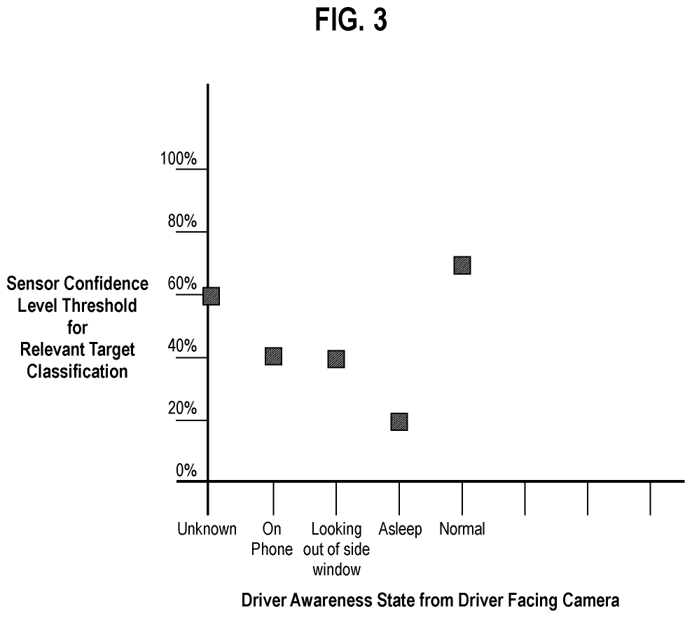

However alertness is assessed, if the one or more processors 150 determine that there is a driver alertness problem, the one or more processors 150 can cause a lower confidence level threshold to be applied to the collision avoidance system 110 (act 230), which has the effect of causing the collision avoidance system 110 to take an automatic intervening action sooner. That is, the collision avoidance system 110 can have multiple activation criteria, which are selectable based on the driver's awareness state. This is illustrated in the graph of FIG. 3. As shown in FIG. 3, in a “normal” (e.g., fully alert) driver-awareness state, the collision avoidance system 110 can use a 75% confidence level (i.e., a 75% confidence level that the target is relevant). If the one or more processors 150 determine that the driver is asleep, the one or more processors 150 can inform the collision avoidance system 110 of that determination, and the collision avoidance system 110 can lower the threshold to 20% (alternatively, in this and the other examples, the one or more processors 150 can inform the collision avoidance system 110 of the threshold number to use). However, if the one or more processors 150 determine that the driver is looking out the side window or is on the phone, a threshold (here, 40%) can be used that is higher than when the driver is determined to be asleep but still lower than the normal threshold. Also, if the one or more processors 150 cannot determine the alertness level of the driver, the one or more processors 150 can cause the collision avoidance system 110 of use a threshold number slightly lower than normal (e.g., 60%), just in case.

As can be seen from the above examples, these embodiments can be used to lower the confidence level threshold of forward-looking sensors based on driver-awareness state (e.g., using a driver-facing sensor), so that an automatic vehicle system (e.g., an advanced emergency braking system) intervenes earlier, preferably without any perceived increase in false-positive interventions. As a result, a greater speed reduction can be possible (e.g., 55-0 MPH, instead of 50-0 MPH on a stationary vehicle). In cases where automatic intervention is not justified, these embodiments can still act as a “wake-up call” for the driver, since intervention sensitivity was probably due to an observed symptom of a distracted or compromised driver. Further, since the confidence level is not changed if the driver is detected to be alert, these embodiments should not meaningfully increase the number of false-positive interventions.

There are many alternatives that can be used with these embodiments. For example, instead of or in addition to increasing the sensitivity of a collision avoidance system, the sensitivity of other autonomous features of the vehicle can be increased in response to detecting impairment of the driver.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to. Also, the term “or” as used herein is to be interpreted as inclusive or meaning any one or any combination. Therefore, “A, B or C” means “any of the following: A; B; C; A and B; A and C; B and C; A, B and C”.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing instructions that, when executed by one or more processors in a vehicle, cause the one or more processors to:
determine that a driver alertness problem exists based on an output of a sensor in the vehicle; and
in response to determining that the driver alertness problem exists, lower a confidence level threshold used by a collision avoidance system of the vehicle.

2. The non-transitory computer-readable storage medium of claim 1, wherein the collision avoidance system comprises an advanced emergency braking system.

3. The non-transitory computer-readable storage medium of claim 1, wherein the collision avoidance system comprises a collision alert system.

4. The non-transitory computer-readable storage medium of claim 1, wherein the collision avoidance system comprises an automated steering controller.

5. The non-transitory computer-readable storage medium of claim 1, wherein the sensor comprises a driver-facing sensor.

6. The non-transitory computer-readable storage medium of claim 5, wherein the driver-facing sensor comprises a driver-facing camera.

7. The non-transitory computer-readable storage medium of claim 5, wherein the driver-facing sensor comprises a lidar sensor positioned to detect head movement of the driver, an infrared sensor positioned to observe a pupil of the driver, or a microphone configured to detect speech of the driver.

8. The non-transitory computer-readable storage medium of claim 1, wherein the sensor is configured to observe a state of the vehicle.

9. The non-transitory computer-readable storage medium of claim 8, wherein the sensor comprises radar, lidar, a vehicle location sensor, a camera, a deceleration sensor, a steering angle sensor, a wheel speed sensor, and a brake pressure sensor.

10. A method comprising:
performing in one or more processors in a vehicle:
determining whether a driver of the vehicle is in a first awareness state or a second awareness state based on a reading from a driver-facing sensor and/or a reading from a vehicle sensor;
in response to determining that the driver of the vehicle is in the first awareness state, causing a driver assistance system of the vehicle to use a first activation criterion in assessing readings from a forward-facing sensor of the vehicle; and
in response to determining that the driver of the vehicle is in the second awareness state, causing the driver assistance system of the vehicle to use a second activation criterion in assessing the readings from the forward-facing sensor of the vehicle.

11. The method of claim 10, wherein the driver assistance system comprises an autonomous braking system.

12. The method of claim 10, wherein the driver assistance system comprises an autonomous steering system.

13. The method of claim 10, wherein the driver assistance system comprises a collision alert system.

14. The method of claim 10, wherein the second awareness state indicates driver impairment, and wherein the driver assistance system is more aggressive in assessing the readings from the forward-facing sensor when using the second criterion than when using the first criterion.

15. The method of claim 10, wherein the driver-facing sensor comprises a driver-facing camera, lidar, an infrared sensor, or a microphone.

16. The method of claim 10, wherein the vehicle sensor comprises radar, lidar, a vehicle location sensor, a deceleration sensor, a steering angle sensor, a wheel speed sensor, and a brake pressure sensor.

17. A vehicle safety system comprising:
means for monitoring for impairment of a driver of a vehicle; and
means for increasing a sensitivity of an autonomous feature of the vehicle in response to detecting impairment of the driver.

18. The vehicle safety system of claim 17, wherein the autonomous feature comprises an automatic braking system.

19. The vehicle safety system of claim 17, wherein the autonomous feature comprises a collision warning system.

20. The vehicle safety system of claim 17, wherein the autonomous feature comprises an automatic steering system.
